(19) United States
(12) Patent Application Publication
(10) Pub. No.: US 2011/0192899 A1
(43) Pub. Date: Aug. 11, 2011

(54) Identification System

(76) Inventor: Elisa Abdulhayoglu, Lynnfield, MA (US)

(21) Appl. No.: 13/056,794

(22) PCT Filed: Jul. 30, 2009
(86) PCT No.: PCT/US09/52197

§ 371 Date: Apr. 25, 2011

Related U.S. Application Data
(60) Provisional application No. 61/085,088, filed on Jul. 31, 2008.

(51) Int. Cl. G06F 17/00

(52) U.S. Cl. 235/382

(57) ABSTRACT

The invention concerns generally systems and methods to provide emergency information related to and identification of an individual, such as an infant, separated from a parent or guardian. The system can be designed such that it increases the likelihood that emergency aid providers can gain access to critical information about those individuals who cannot themselves provide such information. The system generally does not require emergency personnel to use any special devices to access information, and instead allows them to access the information using devices that they commonly use. Moreover, the system is designed to increase the possibility that the information accessed by the emergency personnel is up-to-date.

### CROSS-REFERENCE TO RELATED APPLICATIONS

This application claims priority to U.S. Provisional Patent Application Ser. No. 61/085,088, filed on Jul. 31, 2008, the disclosure of which is hereby incorporated herein by reference in its entirety.

### TECHNICAL FIELD

This invention relates to methods and systems of generating, displaying, storing, updating, and providing access to up-to-date identification information primarily for use in safety related and emergency situations.

### BACKGROUND

Infants, young children, and adults with certain disabilities are unable to articulate their health status or needs to others. When such individuals need medical attention, their parents or guardians must speak for them. In many emergency situations, however, the adult caring for a child or in charge of a disabled person can be unavailable. One example is the scene of a motor vehicle accident. Very often after an accident, the adults and children in the involved vehicle are separated during ambulance rides and are taken to different locations in a hospital, or even to different hospitals. For example, the children are taken to the emergency department of a children's hospital, while the adults are transported to adult trauma centers.

The child or the disabled person is either incapable or ineffectual in telling the attending emergency personnel the necessary details about his or her medical and health condition. Moreover, the parent or guardian is often injured and is unable to communicate, or is at another medical institution. Thus, the medical personnel attending to the child or the disabled adult have no data available to them regarding the patient. The systems and methods according to the invention can be of critical assistance in such situations.

### SUMMARY OF THE INVENTION

The invention relates to systems and methods for linking certain user selectable information to an individual. In various embodiments, the information is stored or printed on a device, and related information about the individual is stored at a unique website. The device is affixed to an object linked to the individual, such as a child's car seat in the case of a child, an infant carrier in the case of an infant, or a wheelchair in the case of a disabled adult. In an emergency situation, emergency personnel can read the information from the device, and they can optionally access the related information stored at the website using the information stored or printed on the device.

The information stored or printed on the device can include a subset (e.g., emergency related) of the website information, and can include the web address of the website where the related information is stored. The information can be stored or printed on the device as text, image, bar code, or a combination of these formats. The device can be a card or label for writing or printing, or it can be a CD or DVD, a USB chip, a magnetic strip, or a smart card, alone or in combination with any other such device.

An authorized person, such as a parent of an infant or a child or a guardian of a disabled adult, can modify the information stored at the website—the information which is related to the child or the disabled adult—so as to ensure that the information at the website is up-to-date. The parent or guardian can select a subset of the related information or select it entirely, and together with the web address of the website, print and store the selected information on the device. The website can be accessed by authorized personnel, such as the parents and guardians, and emergency personnel.

Systems according to the invention are a significant improvement over earlier emergency information systems, such as bracelets or ID cards carried in a wallet or purse. These earlier systems, unlike the present invention, do not store the information on a device, and the same or related information at a remote location. They also do not print the information in a bar code format. These and other features of the present invention can be useful or important for at least several reasons. First, more information can be made available on site to the emergency personnel, if it is stored on a device as opposed to merely printing it. Second, more recent or up-to-date information can be made available if it is stored at a remote location identified by a unique URL. This is because a parent or a guardian can easily and regularly update the remotely stored information as soon as the information changes. Third, using the bar coded information, an emergency responder can save valuable time. Using a bar code scanner, which hospitals commonly use, the responder can easily access the information using the hospital's IT infrastructure. Further, once this information is accessed, it can be quickly and accurately entered into the hospital's electronic records system, eliminating the time and errors associated with entering the information manually into the hospital's records.

The present invention does not require a special writer and reader that may not be available to parents, guardians, and hospitals. Any present or future developed read/write system that has general availability to emergency personnel can be employed.

Unlike other systems, for example those that are designed so that the information can be shared widely for business purposes, only baseline security is provided. To ensure access to the information only by authorized personnel, conventional business information systems require the use of security features such as passwords and unique reader IDs to grant access to the remotely stored information. In an emergency, however, the attending personnel may not carry any special devices and passwords and, hence, overly restrictive security schemes could prevent access to the most up-to-date information from the remote location, when such information can be crucial. The present invention does not require special passwords or other overly restrictive security features. The method and system can still protect the privacy of the person in need of care, by limiting access to the remote location only to the parents or persons in charge of a disabled adult, and to the emergency personnel able to access the physical device in the first instance.

### BRIEF DESCRIPTION OF THE DRAWINGS

The invention is pointed out with particularity in the appended claims. The advantages of the invention described above, together with further advantages, may be better understood by referring to the following detailed description taken in conjunction with the accompanying drawings. The drawings are not necessarily to scale, emphasis instead generally being placed upon illustrating the principles of the invention.

FIG. 1(a) is a schematic representation of a device (e.g., a CD) affixed to a rear of a child car seat according to one embodiment of the invention;

FIG. 1(b) is a schematic representation of a home computer connected to a printer and the Internet for use in practicing one method of the invention;

FIG. 1(c) is a schematic representation of a system to access the information in an emergency according to one method of practicing the invention;

FIG. 2 is a schematic representation of a block diagram according to one method of practicing the invention; and

FIGS. 3(a)-3(c) are schematic representations of one embodiment of a device on which information about an individual is printed in text and bar coded formats.

### DETAILED DESCRIPTION OF THE INVENTION

In one embodiment, the invention includes a system and an associated method for providing up-to-date information to emergency personnel. Parents or persons in charge can create and store the information without requiring any highly specialized tools or techniques. The emergency personnel can easily locate the information with a high probability, and access it using the tools and techniques they commonly use to perform other aspects of their jobs.

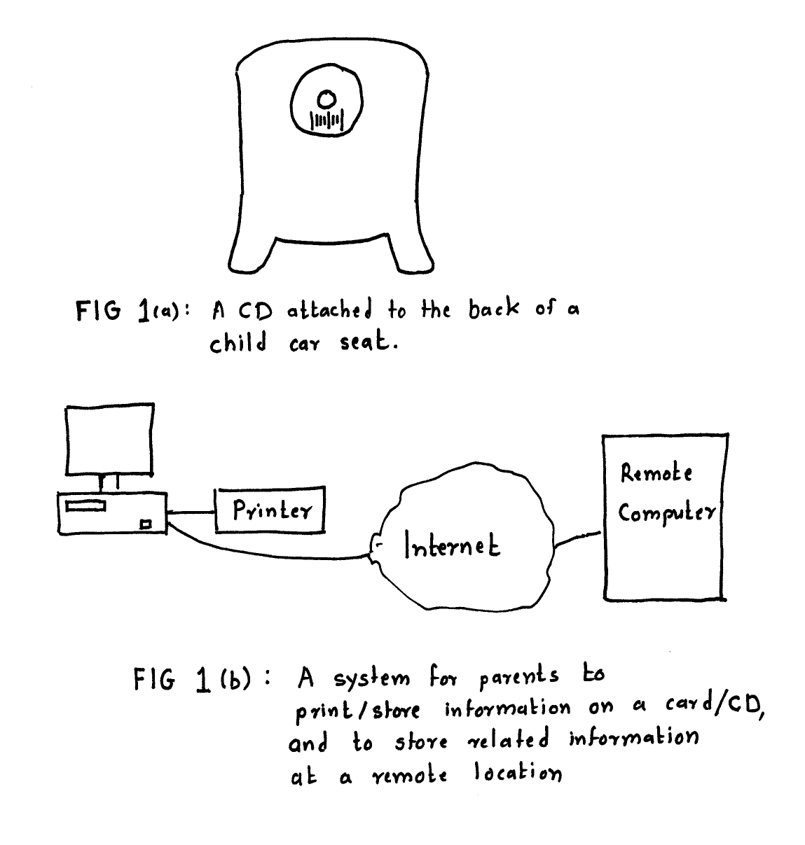

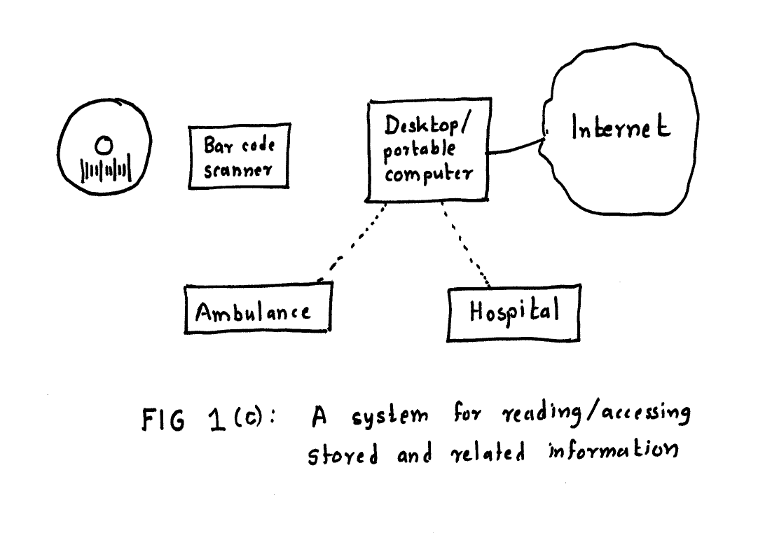

According to one embodiment, illustrated in FIG. 1(a), one feature of the invention is that the device on which the information is printed or stored is affixed to an infant carrier or a child car seat (in the case of infants and children) or a wheelchair (in the case of a disabled adult). The device is readily visible and can display a picture of the infant, child or disabled person, depending on the format of the device. The two factors namely, high visibility and availability of information at a known or standard location, can be important, because in an emergency situation the responders should not waste time searching for information when they are not certain that such information is even available. For example, the emergency personnel should not spend time looking for an information card or tag that might be embedded somewhere in a child's clothing. In the case of a car seat, the information can be affixed where it can always be found, such as on the back or inside a slot where the instruction card is retained. Since emergency personnel routinely transport children in their car seats from the scene of an accident, the information would travel with the children and would be available even when the children are separated from their parents or guardians.

The device on which the information is printed or stored can be a printed card, a CD or DVD, or another electrical, optical, or magnetic storage device, such as a smart card. The parents of a child or the persons in charge of a disabled adult can print some or all of the information on the card or a label which can be affixed to the storage device, for example using a computer system as shown in FIG. 1(b). In one embodiment, the computer has at least one CD/DVD read-write drive and at least one USB port. The computer also includes bar coding software. Using the computer, the information can be stored and printed on a device, and related information can be stored at a remote website. An advantage of the electronic storage device, is that it can contain substantially more information than can be printed on a small area. Moreover, normal wear and tear can render printed information unreadable, but is less likely to damage the stored information. The parents of a child or the persons in charge of a disabled adult can easily print and store the information using a commonly available, home computer connected to the internet, bar coding software, printer, and a CD read/write drive.

Another feature of the invention is that related emergency information can be stored at a remote location having a unique URL. The parents of the child or person in charge of a disabled adult can easily modify the information to ensure that it is up-to-date. To ensure security regarding the entry and modification of the information, the parent or guardian may be required to enter a password before he or she is allowed to access and enter/modify the information.

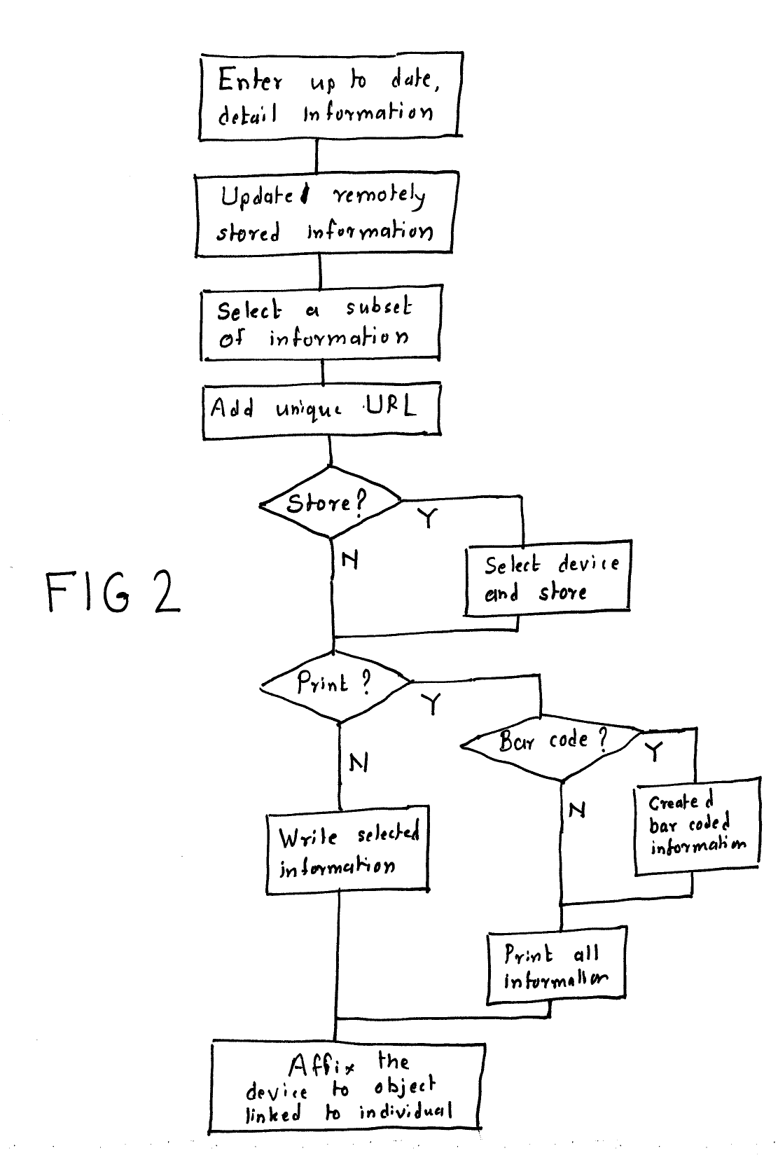

According to one embodiment, shown in FIG. 2, the printed information typically can include the name and address of a child or a disabled person, a relative's contact information, and a unique URL. The stored information further includes critical data regarding the individual, such as a current photograph, date of birth, gestational age at birth (critical if the infant was born prematurely), emergency contact information, contact information of a pediatrician or doctor, drug and food allergies, current medications, current health problems, insurance provider details, and any other relevant information. The printed information may additionally include some or all of the stored details. The format used to print information can be text, bar code, or both. The parent enters the information to be printed/stored and then writes some or all of the information to the device and affixes the device to the object linked to the child.

According to one embodiment shown in FIG. 1(c) in an emergency situation, emergency personnel can access the device, read the printed information, access the stored information (such as reading the CD using a laptop computer, as shown) and/or scan the bar coded information. Using the URL stored or printed on the device and the Internet, the emergency personnel can also access the up-to-date, related information from the hospital or while they are en route in the ambulance. More specifically, the emergency personnel can read the printed information in the text form. Medical and other emergency facilities and even ambulances commonly use bar code readers and, hence, the emergency personnel can also easily read the bar coded information. Such personnel can access the stored information using desktop and laptop computers, also commonly available at emergency facilities. Finally, the emergency personnel can access the remotely-stored, most up-to-date information using the Internet. The remote computer, which hosts the related information, can be programmed to recognize that the requesting computer, according to its IP addresses, belongs to an emergency responder service (such as a hospital, police station, or fire station). Upon such recognition, the host computer may grant immediate access to the stored information. Otherwise, to all other requesting computers, the host may deny access absent a password, in order to protect the information and privacy of the individual to whom the information relates.

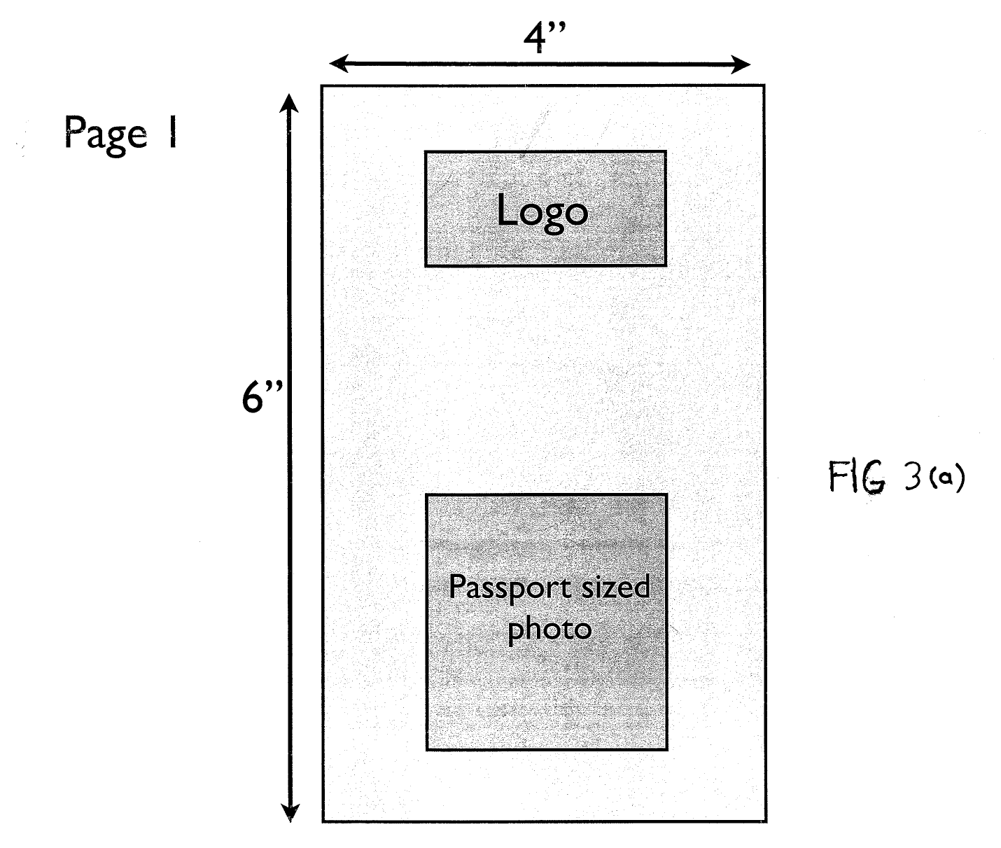

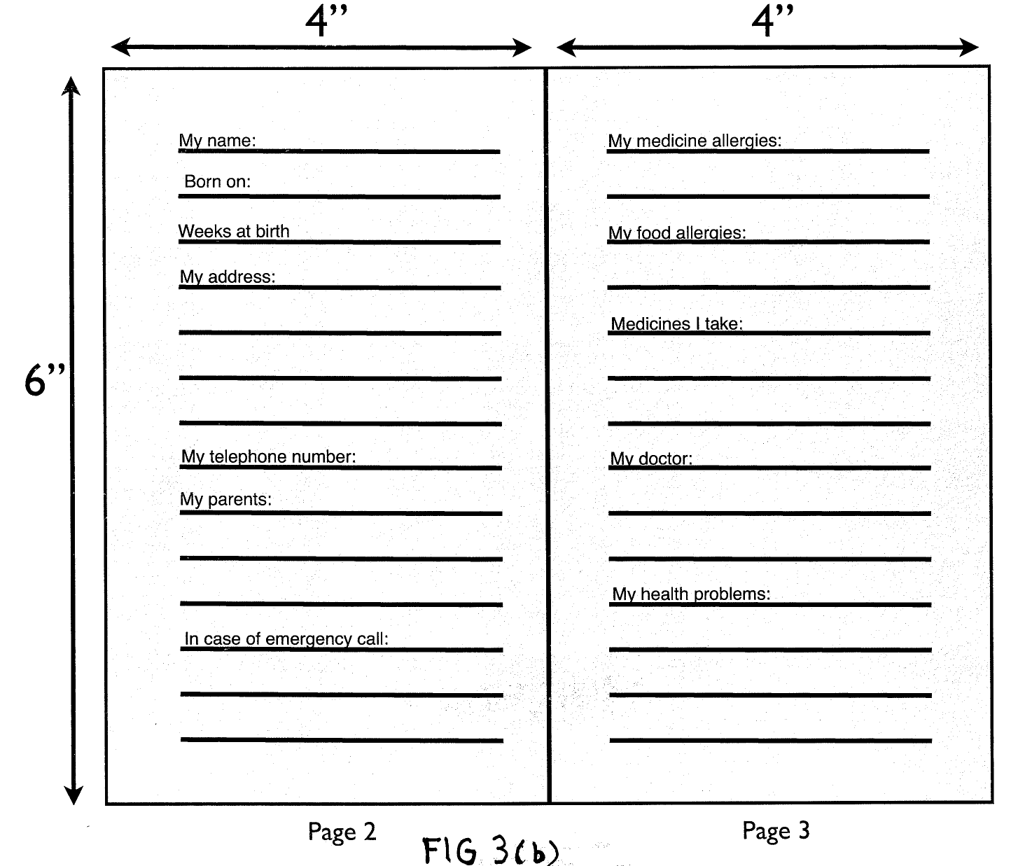

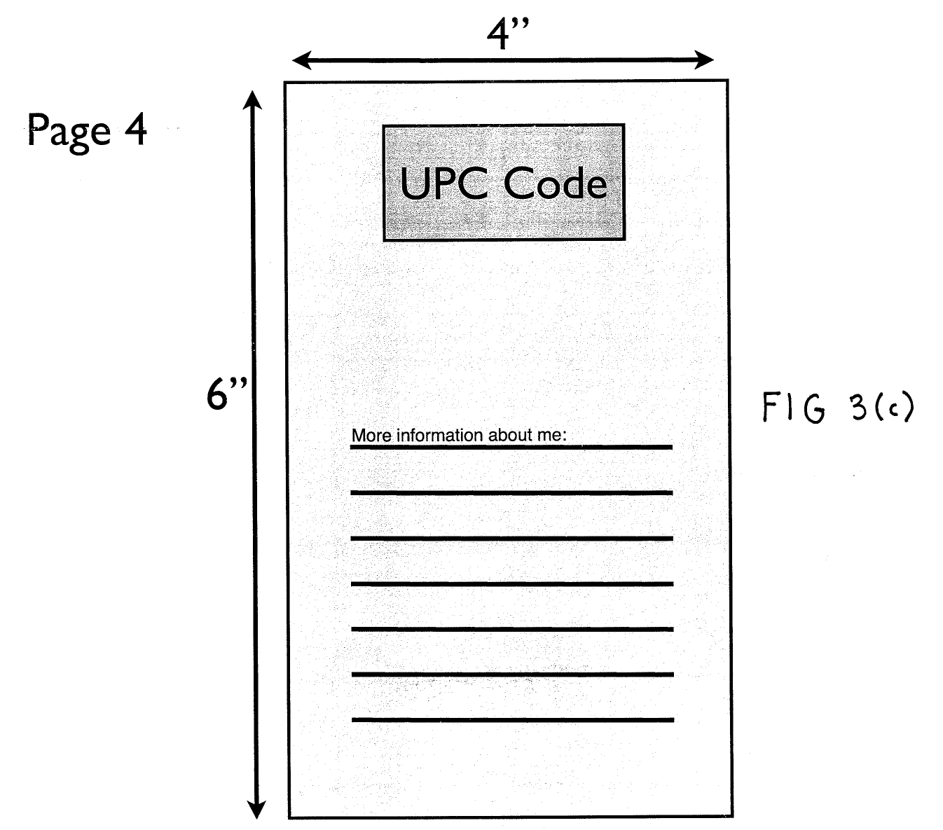

According to one embodiment shown in FIGS. 3(a)-3(c), the device used to provide emergency information can be a printed card described as follows: a folded rectangular laminated card (when folded 4 inches wide by 6 inches long; when unfolded 8 inches wide by 6 inches long), which slides into a plastic sheath attached with adhesive to the infant's car seat or into an existing pocket in the car seat. Alternatively, the embodiment shown in FIGS. 3(a)-3(c) can be formatted for use with a disabled adult. For example, instead of parent, the card can reference a guardian and the card can be attached to a disabled adult's wheelchair, walker, or similar piece of equipment. Additionally, the card could be attached to an article of clothing, for example a vest worn by the disabled adult.

The card can be brightly colored for easy visibility and recognition by emergency personnel. On the top half of the front cover/page one of the card depicted in FIG. 3(a), there can be a universal symbol for medical information (e.g., a red cross), an “EMERGENCY INFORMATION” caption, or other symbol/logo with the official name of the product. Along the lower half of page one, there is an area for parents (or guardian) to affix or print a current photograph of the child (or disabled adult), allowing for immediate linking of the card to the child (or disabled adult).

Page two of the folded card (left side of open card) depicted in FIG. 3(b) can contain lines for parents to write or print the infant's full name, date of birth, gestational age at birth, full address, parent(s) full name(s), and emergency contact information.

Page three of the folded card (right side of open card) also depicted in FIG. 3(b) can contain lines for parents to write or print the child's allergies (including food), medications, pediatrician's name/address/telephone number, and any health problems.

Page four of the folded card (the back cover) depicted in FIG. 3(c) has an individualized UPC bar code and number. Given the advancement of technology in the fields of law enforcement, fire safety, and medicine, this can provide significant value. The written information on the card can be altered or can become unreadable due to wear, age, or damage in the case of a severe vehicular accident. The UPC bar code and number is a “back-up” source of information. Emergency personnel (such as police, fire, and medical staff) can scan the bar code and download the data read, including a unique URL, onto a computer. The computer can be a desk top, or a portable or hand-held computer.

In various embodiments, parents/guardians can purchase a computer software application that provides all of the instructions and software to create the device and linked website. Alternatively, this software application can be purchased as an option or included in the purchase price of an infant carrier, a child car seat, a wheelchair, or similar equipment. For example, parents, when purchasing the car seat, would be given access to a website where they can store the related information. The parents can log-on to the site using a password, and enter all pertinent information for the infant. They can regularly update the child's medical information and photograph. Hospitals could provide the software to all new parents or local police or fire departments could provide the software as part of local safety programs, such as infant and child registration initiatives.

It will therefore be seen that the foregoing represents a versatile and convenient approach to the identification of individuals in emergency situations, including when an individual becomes lost or separated from a parent or guardian for any reason. While there have been described herein various exemplary and preferred embodiments of the invention, other alternatives will become readily apparent to those skilled in the art, based on the teachings herein. The terms and expressions employed are used as terms of description and not of limitation, and there is no intention, in the use of such terms and expressions, of excluding any equivalents of the features shown and described or portions thereof. Various modifications are possible within the scope of the invention described. Accordingly, what is desired to be secured by Letters Patent is the invention as defined and differentiated in the following claims, including all equivalents.

What is claimed is:

1. A method for linking information to an individual, comprising the steps of:
at least one of printing and storing information on a device;
storing related information at a website;
affixing the device to an object linked to an individual;
reading the printed or stored information; and
accessing the related information on the website using the printed or stored information.

2. The method of claim 1, wherein the printed or stored information is emergency related.

3. The method of claim 1, wherein the printed or stored information contains a unique URL.

4. The method of claim 1, wherein the object to which the device is attached is a child car seat.

5. The method of claim 1, wherein the object to which the device is attached is a wheelchair.

6. The method of claim 1, wherein printing format is selected from the group consisting of text, picture, bar coding, and combinations thereof.

7. The method of claim 1, wherein the storing methods include electronic, magnetic, and optical storing.

8. The method of claim 1, further comprising the step of modifying the information stored at the website.

9. The method of claim 1, further comprising the step of restricting access to the website to authorized users.

10. The method of claim 8, wherein the authorized users comprise a creator of the information stored at the website and emergency personnel.

11. The method of claim 1, wherein the device is selected from the group consisting of cards, labels, CDs, DVDs, USB chips, magnetic strip cards, and smart cards.

12. A system for linking information to an individual comprising:
a device for receiving at least one of printed and stored information; and
means for affixing the device to an object linked to an individual, wherein the printed or stored information provides access to at least one website associated with the device and including related information.

13. The system of claim 12, wherein the printed or stored information is emergency related.

14. The system of claim 12, wherein the device is selected from the group consisting of cards, labels, CDs, DVDs, USB chips, magnetic strip cards, and smart cards.

15. The system of claim 12, wherein the object is a child car seat.

16. The system of claim 12, wherein the object is a wheelchair.

17. The system of claim 12, wherein access to the website is restricted to authorized users.

18. The system of claim 17, wherein the authorized users comprise a creator of the information stored at the website and emergency personnel.
